(19) United States
(12) Patent Application Publication
(10) Pub. No.: US 2019/0197415 A1
(43) Pub. Date: Jun. 27, 2019

(54) USER STATE MODELING

(71) Applicant: Koninklijke Philips N.V., Eindhoven (NL)

(72) Inventors: Murtaza Bulut, Eindhoven (NL); Mark Thomas Johnson, Arendonk (BE)

(21) Appl. No.: 16/224,997

(22) Filed: Dec. 19, 2018

Related U.S. Application Data
(60) Provisional application No. 62/609,387, filed on Dec. 22, 2017.

(51) Int. Cl. G06N 5/04; G06F 16/2457; G06F 16/438; G06N 20/00

(52) U.S. Cl. CPC G06N 5/04; G06F 16/24575; G06F 17/28; G06N 20/00; G06F 16/4387

(57) ABSTRACT

Methods and systems for modelling a user's state. Systems and methods described herein receive physiological and/or behavioral data of a user to model the user's state. The user's state is modelled again during or after the user's consumption of a media item. Depending on how the new user state compares to the first user state, the response to a question may be recorded or the process is repeated.

### CROSS-REFERENCE TO RELATED APPLICATION

This application claims the benefit of and priority to U.S. Provisional Application Ser. No. 62/609,387, filed Dec. 22, 2017. These applications are hereby incorporated by reference herein.

### FIELD OF THE INVENTION

Embodiments described herein generally relate to systems and methods for monitoring a user's state and, more particularly but not exclusively, to systems and methods for modeling a user's state based on their reaction to media item(s) consumption.

### BACKGROUND OF THE INVENTION

Questionnaires gather valuable data. Through proper use, questionnaires can monitor practically all aspects of quality of life, such as aspects related to a user's physical, psychological, and social state.

Responding to questionnaires, however, is a time and effort-consuming task and not always practical for monitoring frequent changes in a user's state. For example, questionnaires are often issued to users more than once at defined time intervals. However, people generally do not like answering questionnaires, especially answering the same questions multiple times. Additionally, it may not be clear how to answer questionnaires due to their ambiguity. Accordingly, questionnaires are not always a practical way to gather information from users.

A need exists, therefore, for systems and methods for monitoring a user's state that overcome the disadvantages of existing techniques.

### SUMMARY OF THE INVENTION

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a system for monitoring a user's state. The system includes an interface for receiving a first set of at least one of user behavioral data and user physiological data; a memory; and a processor executing instructions stored on the memory to provide a state prediction module configured to predict a first state of the user using the received user data; and a media module configured to create a playlist of a plurality of media items, the plurality of media items comprising a first media item based on the user's first state, for consumption by the user, wherein the state prediction module is further configured to determine, using a second set of at least one of user behavioral data and user physiological data, a second state of the user resulting from the user's consumption of the selected first media item, and a question generation module configured to select a question from a questionnaire as a function of the user's first state.

In some embodiments, the question generation module is further configured to generate a response to the selected question utilizing the user's first state.

In some embodiments, the media module is further configured to select a second media item upon the state prediction module determining the user's second state does not match the user's first state.

In some embodiments, the user's first state includes at least one of a first qualitative value and a first quantitative value.

In some embodiments, the processor is further configured to determine an initial state of the user using the received user data, and the first media item is selected based on its predicted effect to transition the user from the initial state to the first state.

In some embodiments, the system further includes a source of predictive effect values of each of the plurality of media items on the user.

According to another aspect, embodiments relate to a method for monitoring a user's state. The method includes receiving a first set of at least one of user behavioral data and user physiological data using an interface; predicting a first state of the user based on the received user data using a state prediction module; creating a playlist of a plurality of media items using a media module, the plurality of media items comprising a first media item based on the user's first state for consumption by the user; measuring a second state of the user resulting from the user's consumption of the selected first media item using the state prediction module and a second set of at least one of user behavioral data and user physiological data; and selecting, using a question generation module, a question from a questionnaire as a function of the user's first state.

In some embodiments, the method further includes generating, utilizing the user's first state, a response to the selected question using the question generation module.

In some embodiments, the method further includes selecting, using the media module, a second media item upon the state prediction module determining that the user's second state does not match the user's first state.

In some embodiments, predicting the user's first state includes predicting at least one of a first qualitative value and a first quantitative value.

In some embodiments, the method further includes determining an initial state of the user using the first set of received user data, wherein the first media item is selected based on its predicted effect to transition the user from the initial state to the first state.

In some embodiments, the method further includes retrieving predictive effect values of each of the plurality of media items from a source of predictive effect values.

In some embodiments, the playlist alternates between highly-affective media items and non-highly affective media items.

In some embodiments, the method further includes determining when the question was last selected; and selecting the question upon determining that the time since the question was last selected exceeds a threshold.

In some embodiments, the question from the questionnaire is unanswered; and the method further comprises selecting the first media item to initiate a user state suitable to answer the unanswered question.

In some embodiments, the method further includes selecting a plurality of questions to be asked in an order from the questionnaire, wherein the order of questions to be asked is based on a metric determined from at least one of user location, confidence level, time frame, and duration.

According to yet another aspect, embodiments relate to a computer readable storage medium containing computer-executable instructions for modelling a user's state. The medium includes computer-executable instructions for receiving a first set of at least one of user behavioral data and user physiological data using an interface; computer-executable instructions for predicting a first state of the user based on the received user data using a state prediction module; computer-executable instructions for creating a playlist of a plurality of media items using a media module, the plurality of media items comprising a first media item based on the user's first state, for consumption by the user; computer-executable instructions for measuring a second state of the user resulting from the user's consumption of the selected first media item using the state prediction module and a second set of at least one of user behavioral data and user physiological data; and computer executable instructions for selecting, using a question generation module, a question from a questionnaire as a function of the user's first state.

These and other aspects will be apparent from and elucidated with reference to the embodiment(s) described hereinafter.

### BRIEF DESCRIPTION OF THE DRAWINGS

Non-limiting and non-exhaustive embodiments of the embodiments herein are described with reference to the following figures, wherein like reference numerals refer to like parts throughout the various views unless otherwise specified.

FIG. 1 illustrates a system for modelling a user's state in accordance with one embodiment;

FIG. 2 illustrates a diagram of the components of the system of FIG. 1 in operation in accordance with one embodiment;

FIG. 3 illustrates a workflow of playlist generation and user monitoring in accordance with one embodiment; and

FIG. 4 depicts a flowchart of a method for modelling a user's state in accordance with one embodiment.

### DETAILED DESCRIPTION OF EMBODIMENTS

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Music has long been a part of human life and society. New technology over the past several decades enables people to listen to music just about anywhere and anytime. For example, people can listen to music at home, at work, in their car, in public transportation, outdoors, etc. Similarly, people can listen to music while running, reading, thinking, relaxing, working, etc. Listening to music can also be an individual activity or a group activity.

There has been extensive research on how music affects people's moods and emotions. Music plays an important role in life and different people may respond differently to the same piece of music. In addition to the obvious inter-individual differences, there are intra-individual differences as well. A single individual's response to music can be affected by many factors such as their emotions, their cognitive state, their activities, and their environment. Similarly, there has been research into music playlist generation. In both applications, acoustic features are extracted from music files and may be analyzed using machine learning algorithms.

Although the above discusses music, other types of media, content, or stimuli may be used to accomplish the features of various embodiments described herein. These may include, but are not limited to, songs, audio files, sound segments, speech segments, video imagery, pictures, text, haptic-based stimuli, temperature changes, scents, or the like.

The various embodiments of the systems and methods described herein provide for the automation of an objective approach to the continuous completion of a questionnaire focused on some aspect of the user's affective state. In the context of the present application, the terms “affective state” may include emotions and moods (which tend to last longer than emotions) and states (which are more long term, such as a state of depression). The systems and methods described herein record physiological and/or behavioral signals from a user and uses the signals to manipulate a media item playlist (e.g., a music playlist) so as to confirm a model of the user's affective state which can in turn be used to complete the questionnaire.

More specifically, the systems and methods described herein use a user's physiological and/or behavioral response to one or more media items to automatically complete, for example, a questionnaire focused on the user's affective state. In some embodiments, the methods described herein may receive physiological data and/or behavioral data of a user that is indicative of the user's state to answer the particular question of the questionnaire (or a generated question) that is relevant at that moment. Then, the methods described herein may manipulate a playlist to confirm the prediction of the user's affective state used to answer the question.

The content included in the playlist is specifically chosen so as to transition the user's affective state from an initial state to a desired state; a successful transition confirms the accuracy of the model of the initial state. The physiological measurement for monitoring is the one or more physiological measurements that are most suited to answer the selected question from the questionnaire or a question generated by natural language processing techniques.

The ability of a particular item of content to transition a user from an initial affective state to a desired affective state may have been previously validated by measuring the physiological and/or the behavioral response(s) of the user (or a multiplicity of users) to the particular item of content. The most suitable physiological measurement to monitor the ability of a particular item of content to change affective state may also be validated. The content may also be classified as to its efficacy for transitioning a user from various initial affective states to various desired affective states.

A validation phase may analyze hundreds or thousands of media items and their effects on one or more users after the consumption of each media item. In the context of the present application the term “consumption” refers to the act of a user viewing, listening to, or otherwise being exposed to a media item, content, and/or stimuli (“media item”) such that the media item may have an effect on the user.

In addition to consumption, various embodiments of the systems and methods described herein may consider whether a user skips the media item—either after viewing (e.g., the title) or consuming a portion of the media item (e.g., listening to the first few seconds of a song). The act of listening (or engagement in more general) may include not only listening to most or all of the media item, but also listening to only a part of it and the subsequent user actions (e.g., skipping the media item, listening to the media item again, etc.).

In the context of the present application, the term “effect” with respect to users may relate to some physiological, emotional, and/or behavioral response. For example, the users' heart rate may be monitored before, during, and after the consumption of particular media items to determine what effect, if any, the media items have on the users' heart rate. Knowledge that consumption of a particular song always (e.g., 99% of the time, 90% of the time, etc.) increases a user's heart rate by 10% (e.g., compared to the user's average heart rate) may be stored in one or more databases. As another example, the songs may be analyzed with respect to what effect (if any) they have on the users' respiratory rate. Various embodiments described herein may of course rely on other parameters in addition to or in lieu of heart rate or breathing rate. For example, behavioral responses that may be considered may include how quickly a user skips to the next media item or any other way the user interacts with, for example, a user interface (e.g., by changing the volume, changing bass settings, etc.). Behavioral settings may also include the playback device used (e.g., headphones, speakers, etc.).

Data regarding song features may also be calculated and the relationship between song features and user responses can be determined. Lower level song features (e.g., tempo, frequency, content, lyrics, instruments, vocals, etc.) as well as high level song features (e.g., song name and artist) may be considered.

It is desirable to find songs or other media items that, as often as possible, result in the same physiological and/or behavioral response upon consumption by a user. Again, although this disclosure largely discusses songs as the media items used, other types of media items, content, such as videos, photographs, or some combination thereof, may be used to accomplish the features of various embodiments as discussed herein.

The systems and methods described herein may consider not only the effect(s) of individual media items, but also the anticipated effect of a group of media items. For example, when a group of songs are consumed in a particular order and/or within a certain period of time, they may generate a particular effect. When these songs are consumed in isolation, they may or may not generate the same effect or any effect in general.

Accordingly, features of various embodiments described herein provide novel playlist generation and analysis techniques and systems that take into account the connection between media item effects and the user's state. The pre-media item consumption and post-media item consumption affective states of the user are compared, and the questionnaire item is answered or the process is repeated.

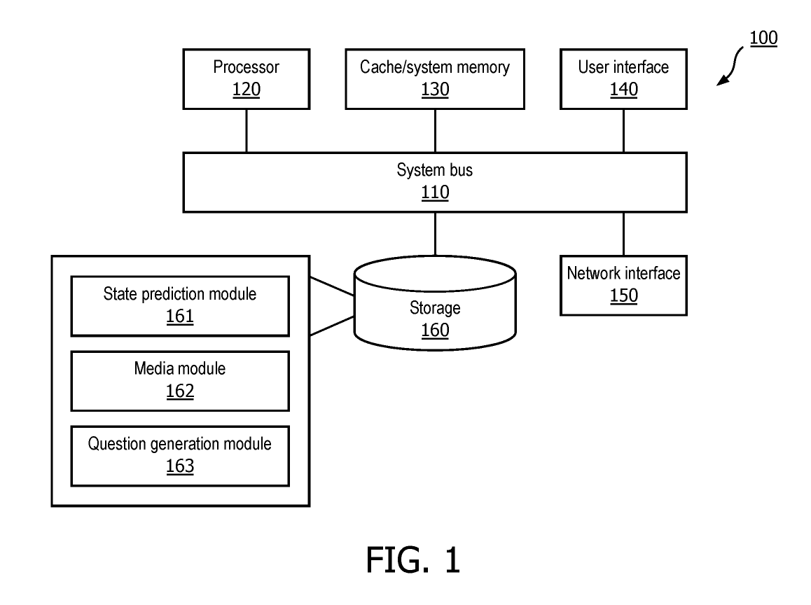

FIG. 1 illustrates a system 100 for modelling a user's state in accordance with one embodiment. The system 100 may include a processor 120, memory 130, a user interface 140, a network interface 150, and storage 160 interconnected via one or more system buses 110. It will be understood that FIG. 1 constitutes, in some respects, an abstraction and that the actual organization of the system 100 and the components thereof may differ from what is illustrated.

The processor 120 may be any hardware device capable of executing instructions stored on memory 130 and/or in storage 160, or otherwise any hardware device capable of processing data. As such, the processor 120 may include a microprocessor, field programmable gate array (FPGA), application-specific integrated circuit (ASIC), or other similar devices.

The memory 130 may include various memories such as, for example L1, L2, or L3 cache or system memory. As such, the memory 130 may include static random-access memory (SRAM), dynamic RAM (DRAM), flash memory, read only memory (ROM), or other similar memory devices and configurations.

The user interface 140 may include one or more devices for enabling communication with a user such as a patient. For example, the user interface 140 may include a display, a mouse, and a keyboard for receiving user commands. In some embodiments, the user interface 140 may include a command line interface or graphical user interface that may be presented to a remote terminal via the network interface 150. The user interface 140 may execute on a user device such as a PC, laptop, tablet, mobile device, or the like.

The network interface 150 may include one or more devices for enabling communication with other hardware devices. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent.

The network interface 150 may be in communication with any external data gathering and/or user monitoring devices. For example, depending on the physiological and/or behavioral parameters considered, the network interface 150 may be in communication with heart rate monitors, galvanic skin sensors, motion monitors, respiration monitors, speech sensors, facial expression sensors, or the like. The exact sensor types used may vary and may depend on the parameters considered. The network interface 150 and/or the user interface 140 may also include sensors or devices to gather behavioral parameters, such as the user's media item skipping patterns and how the user interacts with e.g., the user interface 140.

The network interface 150 may also be in operable communication with one or more databases stored in memory 130 or storage 160. The databases may store data regarding media items and their effects on users (e.g., based on the previously-conducted validation phase(s) such as those discussed above) or data that may be used to compute predictive values for such effects using an algorithm.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions for execution by the processor 120 or data upon which the processor 120 may operate.

For example, the storage 160 may include a state prediction module 161, a media module 162, and a question generation module 163. The state prediction module 161 may receive the user data from the user interface 140 and/or the network interface 150 and predict the user's first state based on the received data. User behavioral data may relate to how a user interacts with a user device such as a computer. This behavioral data may include, but is not limited to, keyboard typing amount, typing corrections, pressure strength (e.g., pressure exerted on a keyboard or touch screen device), mouse-moving characteristics, or the like.

The media module 162 may generate a playlist consisting of media items such as songs. Although the present application largely discusses songs as the consumed media item, it is contemplated that other types of media items or digital media files may be selected for consumption by a user in accord with the discussion herein.

The question generation module 163 may select one or more questions for a user based on the user's state. Additionally or alternatively, the question generation module 163 may generate one or more questions using natural language processing techniques. Based on the user's reaction to the media item, the answer to the question can be inferred and recorded.

The systems and methods described herein operate under the assumption that listening to songs similar in nature to the current affective state of the user either enhances or does not significantly change the user's state. Therefore, neutral songs or songs expected to induce an affective state different than the current affective state can be used as a measurement tool to increase confidence in the automatically-estimated state(s) of the user. In the context of the present application, neutral media items may include those that, upon consumption, are not expected to change the affective state of the user and may therefore have limited affective value for a particular user.

In summary, the user's state is estimated unobtrusively from the received user data. The state estimation may consist of both qualitative and quantitative descriptors. The user state defines which question from a questionnaire will be selected or generated and the playlist is generated by the media module 162.

The media module 162 may select songs (or other media items) for the playlist to be presented after neutral songs. After consumption of the selected song(s), the state prediction module 161 may analyze the newly received user data to estimate the new user affective state. Depending on how the new user state compares to the user's previous state, a question is generated (or previously selected) and the response is recorded, or the process is repeated. Accordingly, the various embodiments of the systems and methods described herein can autonomously ask survey questions relevant to the user's affective state and infer answers to those questions.

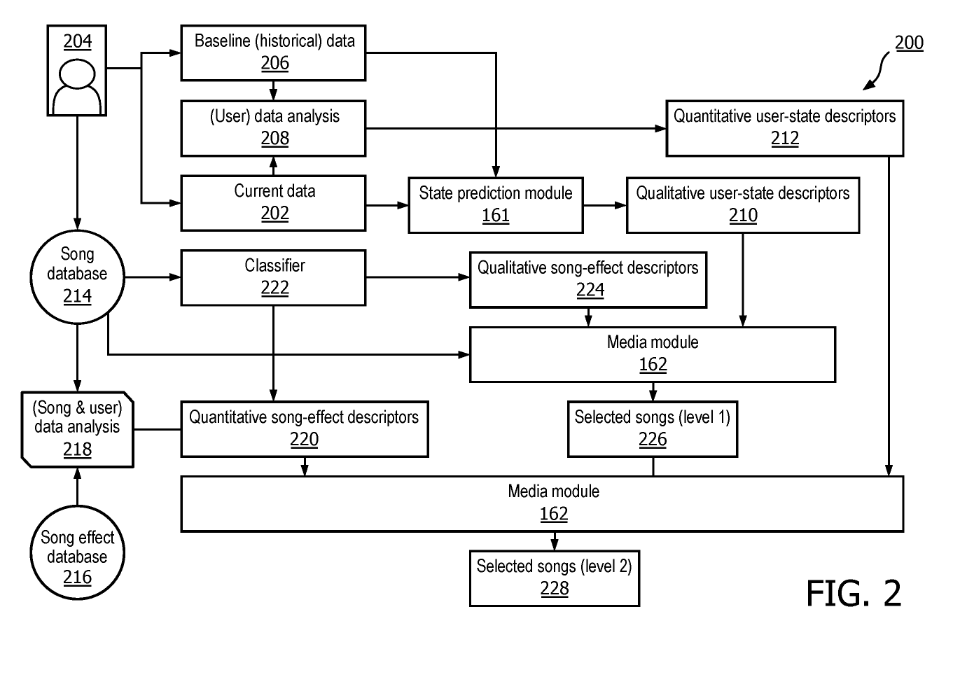

FIG. 2 illustrates a diagram 200 of select components of the system 100 of FIG. 1 in operation. The state prediction module 161 may receive current behavioral data and/or physiological data 202 of a user 204. The state prediction module 161 may also receive or otherwise have access to baseline or historical data 206 of the user 204.

The state prediction module 161 may then perform an analysis 208 of the received user data to predict or otherwise estimate the user's affective state. The output of the state prediction module 161 may be a qualitative descriptor 210 such as “the user is aroused” and may also include a qualitative descriptor 212 such as the arousal level (e.g., “very” or “not very”).

The state prediction module 161 may also calculate the difference between the current data 202 and the user's baseline data 206. For example, the analysis 208 may involve determining that the user 204 is aroused and that their heart rate is 30% higher than a baseline heart rate.

The song database 214 may store songs (or other media items) for use in a playlist. The song effect database 216 may store data regarding the effects of various songs (or other types of media items) on a user's state upon their consumption of the media item(s).

For example, acoustic features calculated from songs may be used in an analysis 218 to estimate the perceived emotional value of the song, both qualitatively and quantitatively. The perceived emotional value may relate to, for example, the user's state of arousal and their arousal level. These values may be determined by the testing or validation phase discussed above.

The acoustic features of the song may also be used in an analysis 218 to calculate the expected influence of the song, in terms of expected changes in the user's physiological data. The expected changes may be calculated using, e.g., data collected from the user and other users. The output is a quantitative estimate of how the physiological parameters will change as a result of listening to the song or other medium item, e.g., heart rate will increase by 20% while listening to the song. These predicted influence values may be supplied as quantitative descriptors 220. A classifier 222 may also output a qualitative song-effect descriptor 224, e.g., “agitating.”

It is noted that the perceived emotional estimates and the predicted influence values may be updated, continuously or intermittently, and are not static. In other words, the effect a particular media item may have on a user may not always be the same. The effect may vary based on, for example, changing user preferences, user context, behavioral parameters, the user's environment, previously consumed media items, etc. Accordingly, a processor such as the processor 120 may execute a procedure that considers the stored emotional estimates and predicted influence values and, in some embodiments, assigns weights to the values to account for other parameters or otherwise recomputes the estimates and values to improve their accuracy.

Using at least the qualitative song descriptor(s) 224 or the quantitative song-effect descriptors 220, the media module 162 may then select a song 226 from the song database 214 such that the perceived emotional characteristics of the song match the estimate of the current affective state of the user 204. For example, if the user is alert or aroused, the media module 162 may select a song 226 that matches the user′ 204 (and/or other users′) alertness or arousal level.

Additionally, the song 226 may be chosen such that its expected influence (e.g., it should increase heart rate by 10% compared to baseline over a particular range of heart rate) is within the particular range of heart beat. The song 226 may be inserted into the playlist such that it is played after a “neutral” song, which may be intended to put the user in a state that is consistent with the user's current affective state.

In some embodiments, a media item may be chosen if a user is in a particular affective state as defined by a range of measurable parameters. In other words, the systems and methods described herein do not need to wait until the user's heart rate is at an exact value to select a particular media item, as long as the heart rate is close to validated values.

For example, suppose a user has a resting heart rate of 60 bpm and a song is known to raise heart rate by 6 beats (i.e., 10% of resting heart rate) between heart rate values of 60 bpm and 90 bpm. It would be helpful to select this song when the user has a current heart rate anywhere within this range, such as with a heart rate of 66 or even higher at 70 bpm or 90 bpm. However, this song would not have this anticipated effect if the user's heart rate is outside of this range (e.g., greater than 90 bpm).

The user's response to the songs is monitored. The state prediction module 161 may determine whether or not the qualitative state of the user is the same before and after the song. If the qualitative state of the user is the same after the song, the state prediction module 161 may note the quantitative difference. If the qualitative state is not the same, the process may be repeated and another song 228 may be selected as described above and played for the user.

Having calculated the quantitative difference when the qualitative state is the same, the state prediction module 161 will compare the computed quantitative difference to the predicted influence value for the media item that was consumed. If the computed quantitative difference equals or exceeds the predicted influence value, then the system can update its estimate of the user's current affective state to reflect the predicted affective state resulting from the consumed media item, as well as updating its records to indicate that its original prediction of the user's affective state pre-consumption was also accurate.

If the computed difference is less than the predicted influence value, then the process can repeat itself with new estimates of affective state derived from the first response measurement and how the measurement compares to baseline data.

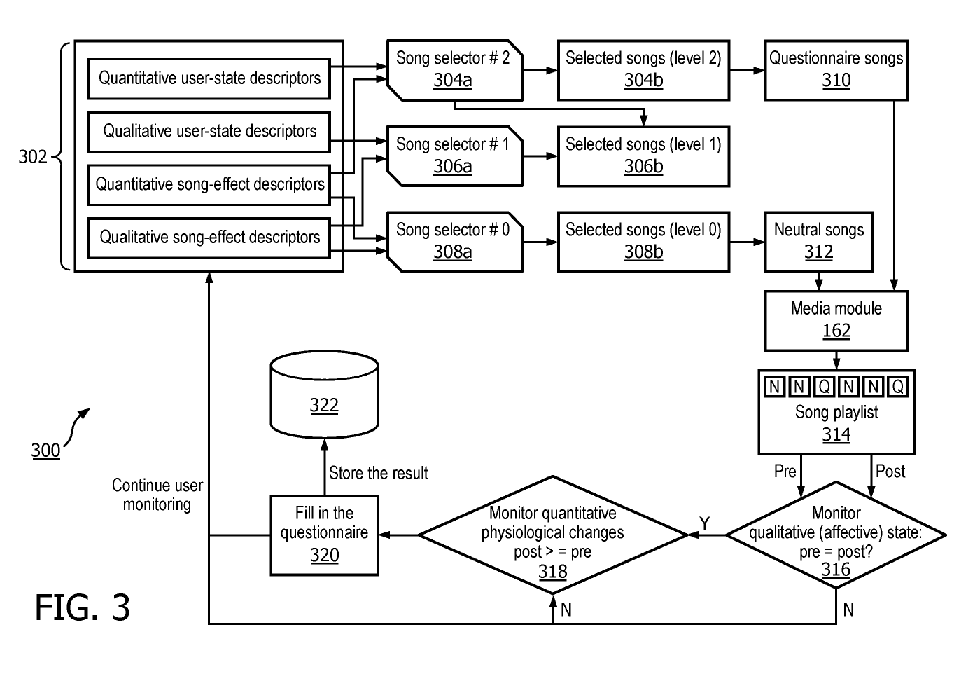

FIG. 3 depicts a workflow 300 of the playlist generation and user monitoring steps in more detail in accordance with one embodiment. The various descriptor labels, indicated collectively by reference numeral 302, may be provided to song selector modules 304a, 306a, and 308a. The output of each of the song selector modules 304a, 306a, and 308a may be selected songs 304b, 306b, and 308b, respectively.

The selected songs 304b that correspond to “level 2” are based on the quantitative descriptors of the song(s) and the user's state. The selected songs 306b that correspond to “level 1” are based on the qualitative descriptors of the song(s) and the user's state. The selected songs 308b that correspond to “level 0” may include neutral songs 312 that are not based the user's state but instead only the quantitative and qualitative descriptors of the song. Rather, these neutral songs 312 are those that are expected to have a neutral or minimal effect on a user.

The questionnaire songs 310 and the neutral songs 312 may be communicated to or otherwise accessed by the media module 162 so that the media module 162 can generate the media item (e.g., song) playlist 314. As seen in FIG. 3, the playlist 314 may alternate between neutral songs 312 and questionnaire songs 310, or include sequential questionnaire songs 310 (see below).

For example, the playlist may alternate between highly affective songs and non-highly affective (e.g., neutral) songs. The highly affective song (e.g., a “happy” song) may provide information on the user's high arousal state. At the end of the “happy” song, the user should be in a high arousal state if the next question concerns a low arousal state of the user (e.g., which can be measured by playing a relaxing song). At this point, the user will hopefully be in a relaxed state, and the media module 162 may then select an “angry” song to put the user in an “angry” state. Accordingly, neutral songs are meant to keep the user in a particular state, while low arousal songs are meant to bring users into relaxed states.

Similarly, the playlist may alternate between songs with different affective content (e.g., high arousal vs. low arousal) than the current affective state. Similar to the use of neutral songs, this playlist construction may provide more confidence that the measured affective state is accurate and can therefore be used as a quality or confidence metric.

For example, a playlist may include neutral songs and alternating high arousal and low arousal songs in the order of:
(1) Neutral
(2) Neutral
(3) High Arousal
(4) Low Arousal
(5) Low Arousal
(6) High Arousal
(7) Neutral
(8) Neutral
(9) High Arousal
(10) Low Arousal

In this type of playlist, songs 3, 4, 6, 9, and 10 are questionnaire songs that are chosen to answer a question. The remaining songs are chosen to set up an initial state.

User monitoring devices may gather user data before and after the user consumes the media item. In step 316 of FIG. 3, the state prediction module 161 may analyze the pre-consumption and post-consumption data to determine the user's state before and after the user consumes the media item (e.g., listens to a song).

Ideally, the user's qualitative state after consumption is similar to what it was before consumption. If the user's state is not the same (e.g., the user was happy before consumption, but is angry after consumption), the user devices may continue to monitor the user.

If the user's qualitative state after consumption is the same (e.g., the user was happy before consumption and is still happy (but perhaps a bit more or a bit less happy) after consumption), the state prediction module 161 may analyze the quantitative physiological (and/or behavioral) changes in step 318 to determine the quantitative differences. For example, the state prediction module 161 may determine by how much the user's heart rate has changed.

If the quantitative change in data is equal to or greater than the difference value with respect the baseline state of the user, then the state prediction module may conclude that its initial user state prediction was correct. The estimate of the user's state may then be used to complete a questionnaire in step 320 about the user's state (e.g., how they are feeling) or otherwise answer a question generated by the question generation module 163. The result may then be stored in one or more databases 322.

If the quantitative change in user data is less than the difference value with respect to the baseline state of the user, the user devices may continue to monitor the user and begin the process again with new estimates of affective state and new calculations of differences from baseline measurements. Accordingly, no answers to the questions are generated or selected at this time.

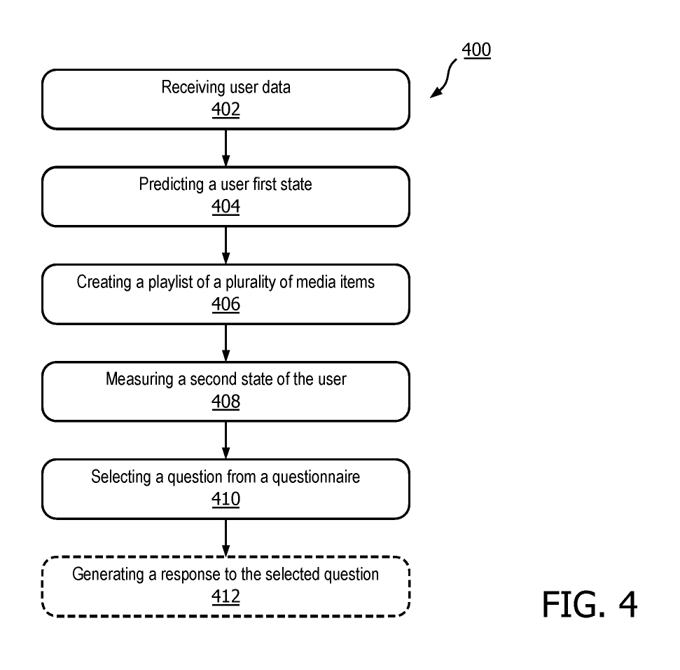

FIG. 4 depicts a flowchart of a method 400 for modelling a user's state in accordance with one embodiment. Step 402 involves receiving at least one of user behavioral data and user physiological data using an interface. The interface may be similar to the interfaces 140 and/or 150 of FIG. 1 and may receive the user data from a variety of user monitoring devices. As mentioned earlier, these may be galvanic skin sensors, heart rate sensors, temperature sensors, input/output devices, or the like.

Step 404 involves predicting a first state of the user based on the received user data using a state prediction module such as the state prediction module 161 of FIG. 1. To predict the user's state, the state prediction module may output both a quantitative value and a qualitative value.

Step 406 involves creating a playlist of a plurality of media items using a media module. The plurality of media items may include a first media item based on the user's first state for consumption by the user. Step 406 may be performed by a media module such as the media module 162 of FIG. 1. The playlist may include one or more neutral songs as well as one or more songs designed to elicit certain responses from the user.

Step 408 involves measuring a second state of the user resulting from the user's consumption of the selected first media item. This step may be performed using the state prediction module and the user data received during or after the user consumes the media item. User data may be monitored before and after the user consumes the media item(s). This user data may be same type of user data received in step 402.

Step 410 involves selecting, using a question generation module, a question from a questionnaire or generating a question as a function of the user's first state or the user's second state. At this point, the user's predicted state that was predicted in step 404 has been confirmed. The question may relate to how the user is feeling or how aroused or alert they are, for example. Step 412 may involve generating a response to the selected question using the question generation module. This answer may be based on at least one of the user's first state or the user's second state.

In some embodiments, the system 100 may manipulate the playlist in an effort to place the user in a certain state. For example, a processor such as the processor 120 may determine when a certain question was last selected. The question generation module 163 may then select a certain question upon the processor determining that the time since the question was last selected exceeds a threshold. That is, if a certain question hasn't been asked for, e.g., two weeks, its priority may be elevated.

Similarly, if there is a question that has not yet been asked, or if it has not been asked recently, it may be selected. The media module may then select one or more media items to initiate a user state that is suitable to answering the question.

In some embodiments, the question generation module 163 may select a plurality of questions to be asked in a certain order to improve the quality of the answers. These metrics may be determined by at least one of the user's location, time frame, confidence level in the user's state, and the expected duration of the question generation process. For example, to improve duration, subsequent questions may be sorted and generated so that questions measuring similar states such as irritated, angry, furious, or the like, are adjacent to each other.

To summarize, a user's state is estimated unobtrusively directly from the measured physiological and/or behavioral signals. The state estimation may involve both qualitative and quantitative outputs.

The estimated user state defines which songs or media items will be selected and how the playlist will be generated. The selected songs may be presented after “neutral” songs, and the response of the user is measured to estimate a new user state. Depending on how the new user state compares to the first user state, the response to a question may be recorded or the process is repeated.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

1. A system for modelling a user's state, the system comprising:
an interface for receiving a first set of at least one of user behavioral data and user physiological data;
a memory; and
a processor executing instructions stored on the memory to provide:
a state prediction module configured to predict a first state of the user using the received user data; and
a media module configured to create a playlist of a plurality of media items, the plurality of media items comprising a first media item based on the user's first state, for consumption by the user,
wherein the state prediction module is further configured to determine, using a second set of at least one of user behavioral data and user physiological data, a second state of the user resulting from the user's consumption of the selected first media item, and
a question generation module configured to select a question from a questionnaire as a function of the user's first state.

2. The system of claim 1 wherein the question generation module is further configured to generate a response to the selected question utilizing the user's first state.

3. The system of claim 1 wherein the media module is further configured to select a second media item upon the state prediction module determining the user's second state does not match the user's first state.

4. The system of claim 1 wherein the user's first state includes at least one of a first qualitative value and a first quantitative value.

5. The system of claim 1 wherein the processor is further configured to determine an initial state of the user using the first set of received user data, and the first media item is selected based on its predicted effect to transition the user from the initial state to the first state.

6. The system of claim 1 further comprising a source of predictive effect values of each of the plurality of media items on the user.

7. A method for modelling a user's state, the method comprising:
receiving a first set of at least one of user behavioral data and user physiological data using an interface;
predicting a first state of the user based on the received user data using a state prediction module;
creating a playlist of a plurality of media items using a media module, the plurality of media items comprising a first media item based on the user's first state, for consumption by the user;
measuring a second state of the user resulting from the user's consumption of the selected first media item using the state prediction module and a second set of at least one of user behavioral data and user physiological data; and
selecting, using a question generation module, a question from a questionnaire as a function of the user's first state.

8. The method of claim 7 further comprising generating, utilizing the user's first state, a response to the selected question using the question generation module.

9. The method of claim 7 further comprising selecting, using the media module, a second media item upon the state prediction module determining that the user's second state does not match the user's first state.

10. The method of claim 7 wherein predicting the user's first state includes predicting at least one of a first qualitative value and a first quantitative value.

11. The method of claim 7 further comprising determining an initial state of the user using the received user data, wherein the first media item is selected based on its predicted effect to transition the user from the initial state to the first state.

12. The method of claim 7 further comprising retrieving predictive effect values of each of the plurality of media items from a source of predictive effect values.

13. The method of claim 7 wherein the playlist alternates between highly-affective media items and non-highly affective media items.

14. The method of claim 7 further comprising:
determining when the question was last selected; and
selecting the question upon determining that the time since the question was last selected exceeds a threshold.

15. The method of claim 7 wherein the question from the questionnaire is unanswered;
and the method further comprises selecting the first media item to initiate a user state suitable to answer the unanswered question.

16. The method of claim 7 further comprising selecting a plurality of questions to be asked in an order from the questionnaire, wherein the order of questions to be asked is based on a metric determined from at least one of user location, confidence level, time frame, and duration.

17. A computer readable storage medium containing computer-executable instructions for modelling a user's state, the medium comprising:
computer-executable instructions for receiving a first set of at least one of user behavioral data and user physiological data using an interface;
computer-executable instructions for predicting a first state of the user based on the received user data using a state prediction module;
computer-executable instructions for creating a playlist of a plurality of media items using a media module, the plurality comprising a first media item based on the user's first state, for consumption by the user;
computer-executable instructions for measuring a second state of the user resulting from the user's consumption of the selected first media item using the state prediction module and a second set of at least one of user behavioral data and user physiological data; and
computer executable instructions for selecting, using a question generation module, a question from a questionnaire as a function of the user's first state.
